(19) United States
(12) Patent Application Publication
(10) Pub. No.: US 2019/0080449 A1
(43) Pub. Date: Mar. 14, 2019

(54) METHOD AND SYSTEM FOR IDENTIFYING AND MEASURING A DEFECT THAT REDUCES TRANSPARENCY IN A SUBSTRATE FOR A SECURITY DOCUMENT

(71) Applicant: CCL SECURE PTY LTD, Craigieburn, Victoria (AU)

(72) Inventors: Ben Paul Stevens, Craigieburn, Victoria (AU); Darren Phillips, Craigieburn, Victoria (AU)

(73) Assignee: CCL SECURE PTY LTD, Craigieburn, Victoria (AU)

(21) Appl. No.: 16/084,846

(22) PCT Filed: Apr. 28, 2017
(86) PCT No.: PCT/AU2017/050392

§ 371 Date: Sep. 13, 2018

(30) Foreign Application Priority Data
Apr. 29, 2016 (AU) 2016100492

(51) Int. Cl. G06T 7/00; G06K 9/00

(52) U.S. Cl. CPC G06T 7/0004; G06K 9/00442; G06T 2207/30176; G06T 2207/30144; G06T 2207/10024

(57) ABSTRACT

A method of measuring a defect level of a region of a substrate for a security document, wherein the defect level is associated with reduced transparency of the region of the substrate, the method including the steps of: digitally imaging the region to create a digital image, the digital image containing light intensity data; and analysing the digital image including: calculating a statistical measure of the light intensity data in the region; and assigning a defect score to the region based on the statistical measure of the light intensity data in the region.

### TECHNICAL FIELD

This invention relates in general to a method of measuring a defect that reduces transparency in a substrate. In particular, the substrate is for a security document, and more particularly the defect can be measured in a transparent window region of the security document, and it is convenient to describe it in this manner. However, it should be noted that the invention is not limited to this application.

### Definitions

As used herein, the term security document includes all types of documents of value and identification documents including, but not limited to: items of currency such as bank notes, credit cards, cheques; passports; identity cards; securities and share certificates; driver's licences; deeds of title; travel documents such as airline and train tickets; entrance cards and tickets; birth death and marriage certificates; and academic transcripts.

The term substrate, as used herein, refers to the base material from which a security document is formed.

As used herein, the term window refers to a transparent or translucent area in the security document compared to the substantially opaque region to which printing is applied. The window may be fully transparent so that it allows the transmission of light substantially unaffected, or it may be partly transparent or translucent partially allowing the transmission of light but without allowing objects to be seen clearly through the window area.

### BACKGROUND OF INVENTION

Security documents using polymer film offer many advantages over traditional paper security documents, including longer life and enhanced security. One of the major reasons for enhanced security in polymer security documents is the use of a transparent area, or window, in the document.

However, the use of transparent windows in security documents can cause problems for security document processing equipment such as automatic teller machines (ATMs), banknote counting machines and the like if the windows do not allow a sufficient amount of light to be transmitted through them. In addition, the security documents may be considered unacceptable if there is a problem which results in reduced transparency in the window.

Defects that reduce transparency in a substrate such as a window can take many forms. One form of these defects is a fault in the substrate, sometimes referred to as ‘hazing’ because the defect appears as a ‘haze’ in the substrate. Another more common form of defect occurs when an ink is laid down on the substrate in areas which are not intended to have ink, or not intended to have that particular ink. In the printing industry this is often referred to as ‘toning’ or ‘scumming’. However, the defect may be referred to by other terms such as ‘soiling’. Defects which affect the clarity of a substrate may be, for example, a faint scum of ink which looks streaky (as bands) or cloudy (in various shapes). A certain level of these defects may be acceptable, but when the transparency is reduced too much, the defects become unacceptable. Further, the allowable level of a defect will vary depending on the substrate used and the application it is intended for.

The only presently reliable method of assessing these types of defects is a manual quality inspection process, generally shown in FIG. 1. The manual inspection method for identifying defects in windows of a security document involves a person 1 holding up a sample of a security document substrate 2 at arm's length and looking through each window 3 in turn while tilting the sample 2 into an overhead light source 4 or a black background (not shown). The person assessing the substrate will identify the strength and size of the defect and hence determine the severity of the defect and whether the defect renders the substrate of unacceptable quality. However, because of the manual nature of the inspection process there is a level of subjectivity depending on the person undertaking the process.

A semi-automated method for assessing these types of defects is to use a ‘haze meter’. A haze meter measures the transparency, haze, see-through quality, and total transmittance of a material, based on how much visible light is diffused or scattered when passing through that material. More scatter from the haze meter means that there is a higher level of ‘toning’ or a stronger, more problematic, defect in the sample. A major drawback of this method is that haze meters generally only analyse small samples. This can result in defects not being identified or defects being exaggerated because parts of the substrate may not be tested. Inaccurate readings can also result from analysing small regions that are not representative of the larger substrate. Further, the results generated from this method have a very poor correlation with the rating of the manual quality inspection process which is considered to be the most accurate method available at the moment.

Another semi-automated method used to assess transparency of a substrate and identify defects which reduce transparency within a substrate uses an opacity meter. An opacity meter is a photoelectric detector that indicates opacity by a single beam of light through a test area. This method includes colour analysis such as RGB (red, green, blue) colour band and uses interference of light as it passes through the substrate to identify defects. This method has similar disadvantages to the haze meter method and it also has poor correlation to the manual quality inspection process described above.

It is desirable to provide an improved method for identifying a defect that reduces transparency in a substrate for a security document.

It is also desirable to provide an improved method of measuring a transparency reducing defect in a window feature of the substrate for a security document.

Any discussion of documents, devices, acts or knowledge in this specification is included to explain the context of the invention. It should not be taken as an admission that any of the material formed part of the prior art base or the common general knowledge in the relevant art in Australia on or before the priority date of the claims herein.

### SUMMARY OF INVENTION

According to one aspect of the present invention, there is provided a method of measuring a defect level of a region of a substrate for a security document, wherein the defect level is associated with reduced transparency of the region of the substrate, the method including the steps of: digitally imaging the region to create a digital image, the digital image containing light intensity data; and analysing the digital image including: calculating a statistical measure of the light intensity data in the region; and assigning a defect score to the region based on the statistical measure of the light intensity data in the region.

Preferably the statistical measure is standard deviation.

The method of measuring a defect level of a region of a substrate may further include the step of comparing the defect score of each region with a predefined defect score range. The method may also further include the step of determining whether the defect score of each region is within the predefined defect score range based on said comparison. The method may also further include the step of transmitting a defect level signal to an output device based on said comparison. These steps are advantageous because they assist in identifying the acceptability of the defect level. Transmission of the defect level signal provides a mechanism for notification of the acceptability of the defect level.

The method may include an additional step of saving the digital image in a database. It may also further include the step of recording the defect score of the region in the database. Again, these steps are advantageous because the image acquired can be saved and analysed. It also enables a record of the defects to be kept and the images and defects referred to at a later stage.

The digital image generated may be a greyscale image, and the light intensity data may be in shades of grey, varying from black to white.

Alternatively, the digital image generated may be a colour image. In this case the light intensity data may be in multiple colour bands. The multiple colour bands may be any one of: RGB (red, green, blue); HSV (hue, saturation, value); or CMYK (cyan, magenta, yellow, key black). If multiple colour bands are used, the statistical measure of the light intensity data may be calculated in each colour band

According to another aspect of the present invention, there is provided a method of correcting a defect level in a printing press for printing a security document, including the steps of: measuring a defect level of a region of a substrate for the security document using the method described above; and comparing the defect score of the region with a predefined defect score range, wherein, if the defect score of the region is outside the predefined defect score range, correcting the defect level in the printing press to be within the predefined defect score range.

According to another aspect of the present invention, there is provided a method of authenticating a security device in a security document including the steps of: measuring a defect level of a region of a substrate for the security document according to the method described above; determining a defect score of the region; comparing the defect score of the region with a predefined defect score range indicative of an authentic security device; and determining if said security document comprising said region is authentic or otherwise based on said comparison.

According to another aspect of the present invention, there is provided a system for measuring a defect level of a region of a substrate for a security document, wherein the defect level is associated with reduced transparency of the region of the substrate and providing information about a quality of the substrate of the security document, including: an imaging device for creating a digital image of an area of the substrate containing the region, the digital image containing light intensity data; and an image analysis apparatus for: calculating a statistical measure of the light intensity data in the region; and assigning a defect score to the region based on the statistical measure of the light intensity data in the region.

The image analysis apparatus may further carry out the steps of: comparing the defect score of the region with a predefined defect score range; determining whether the defect score of each region is within the predefined defect score range based on said comparison; and transmitting a defect level signal to an output device, based on said comparison.

In a particularly preferred embodiment, the region of the substrate in which the defect level is measured is a security device, for example, for incorporation in a security document. In yet a more particularly preferred embodiment, the security document is a banknote.

Furthermore this process has the advantage of being able to be used in real time to allow the operator of a press to identify if the defect accords to quality standards. The method can be implemented on a printing press and the press can then be constantly adjusted in various ways to minimise defects which are identified. This advantageously minimises the amount of scrap which would otherwise be generated.

### BRIEF DESCRIPTION OF DRAWINGS

It will be convenient to further describe the invention with respect to the accompanying drawings. Other embodiments of the invention are possible, and consequently, the particularity of the accompanying drawings is not to be understood as superseding the generality of the preceding description of the invention.

FIG. 1 shows a prior art manual method of inspecting a substrate for defects which affect the transparency of the substrate.

FIG. 2 shows a method of identifying a defect according to an embodiment of the present invention.

FIG. 3 shows a system according to another embodiment of the present invention used in the method shown in FIG. 2.

FIG. 4 shows a method according to a further embodiment of the present invention.

FIG. 5 shows a system according to another embodiment of the present invention, which is used in the method shown in FIG. 4.

FIG. 6 shows varying strengths of defects analysed using a method of the present invention.

FIG. 7 shows a resulting statistical measure obtained using the method of the present invention.

### DETAILED DESCRIPTION

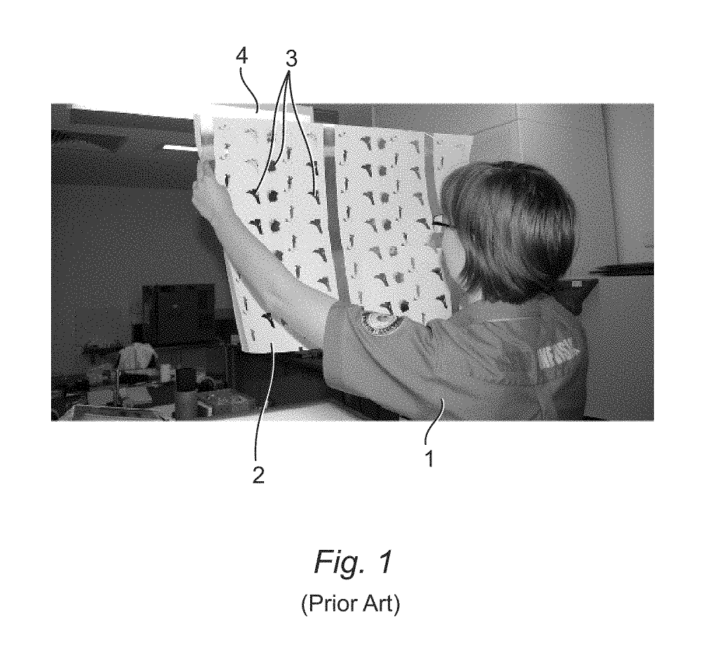

Although the manual inspection process shown in FIG. 1 is currently the most reliable method of identifying and measuring a defect in a region of a substrate and allocating a severity rating to the defect, there are significant drawbacks to this method. These drawbacks include that defect ratings have the potential to change depending on the person inspecting the sheets. Furthermore, the results obtained by this method are subjective and therefore it is not possible to accurately compare defects from different substrates or easily compare defects identified by different people.

To address these disadvantages, an improved method to identify and measure the severity of the defects was developed. An automated method that effectively identifies defects affecting the transparency of a region of a substrate and measures a defect level of the region, is now described.

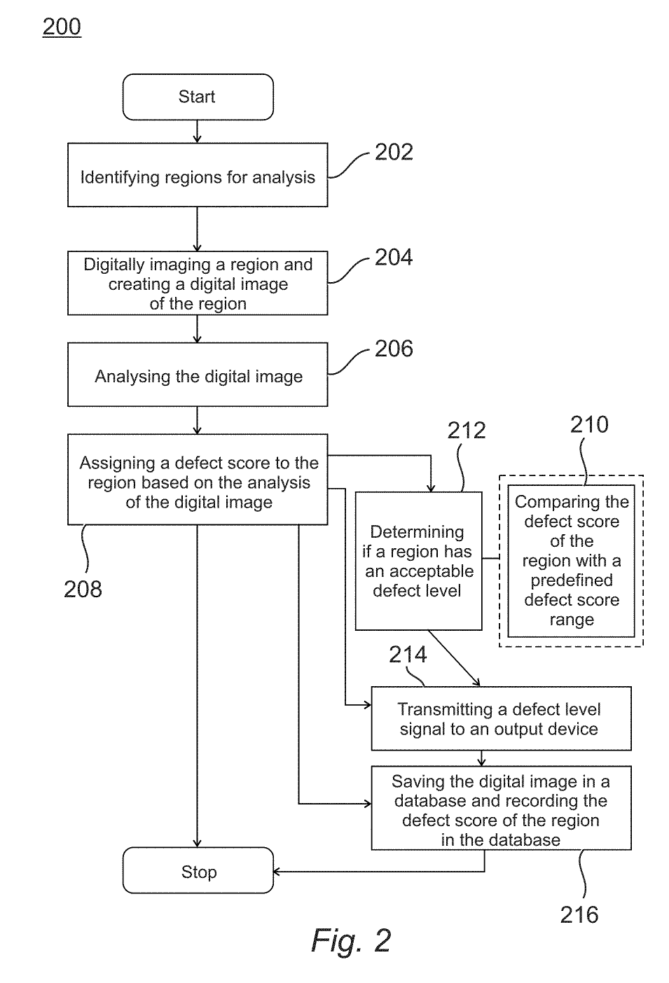

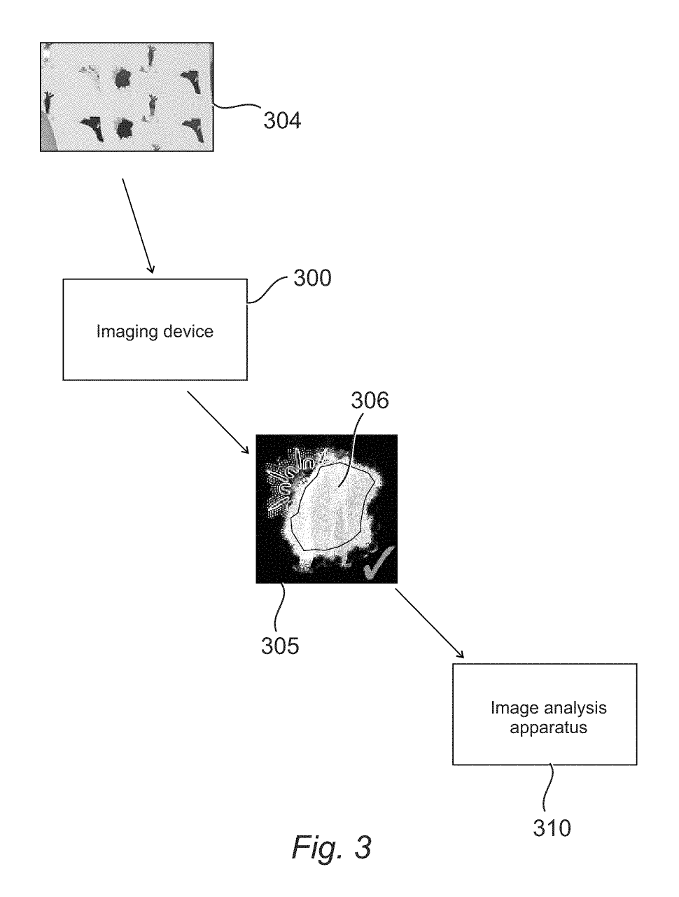

An embodiment of the method of identifying defects, shown in FIG. 2, may be performed using a system shown in FIG. 3. A substrate for a security document 304 is reviewed and regions of the substrate for defect analysis are identified 202. An imaging device 300 is used to digitally image 204 the region 306 of the substrate to be analysed. The imaging device 300 may be, for example, a scanner, a digital camera or even a mobile phone. Alternatively, the imaging device may be a combination of specialist imaging equipment, for example, specialised camera equipment and/or scanning equipment. In a particularly preferred embodiment, the imaging device is an in-line inspection imaging device on a printing press.

An image analysis apparatus 310 analyses the digital image 206. The digital image 305 created by the imaging device 300 contains light intensity data. The light intensity data comprises the light intensity for each pixel within the region of the substrate analysed for defects. A statistical measure is used to analyse the light intensity data. From this, the image analysis apparatus 310 assigns a defect score 208 to the image 305, and hence the region 306 represented in the image. That is, a defect score is assigned to the region 306 based on the statistical measure of the light intensity data in the region. Even though the naked eye may not identify the defect in the substrate, using the method described will identify even the smallest defect.

The statistical measure of the light intensity data may be, for example, standard deviation, mean, or mode. However, in a particularly preferred embodiment, the statistical measure of the light intensity data is standard deviation. Other statistical measures or combination of statistical measures may also be used.

In an embodiment, the method may also be used for identifying whether the region of the substrate has an acceptable defect level, that is, whether the region of the substrate is of acceptable quality. In such an embodiment, the method described above including steps 202, 204, 206 and 208 (and shown in FIG. 2) includes any one or more of a number of further steps (also shown in FIG. 2). One additional step determines whether each region has an acceptable defect level 212. This determination may result from comparing the defect score of each region with a predefined defect score range which is indicative of an acceptable defect level 210. Optionally, a defect level signal may be transmitted to an output device to inform a user whether the sample is considered outside, or within the defect score range 214. This signal may be transmitted by the image analysis apparatus 310.

The defect level that is acceptable, or not acceptable, varies depending on a particular application or particular requirements. In terms of security documents, the defect level corresponding to a window region of the substrate having a defect that reduces transparency of the window but that is still considered acceptable (that is, not spoilt) will depend on a number of factors including, but not limited to: the type of security document; the area of the window region; the type of window feature; whether the window feature is to be transparent or only partially transparent; any colours that are being used in the window feature; or whether something is applied to the window feature, such as foil.

In other embodiments, the method of measuring a defect level of a region of a substrate for a security document may also include a step associated with saving the digital image 216, for example, to a database. Another or alternative step that can be undertaken is to record the defect score in the database 216. The steps of saving the image of the region containing the defect and recording the associated defect score are advantageous, allowing comparison of defects from different batches of substrate produced as well as analysing the types of defects that occur and are identified.

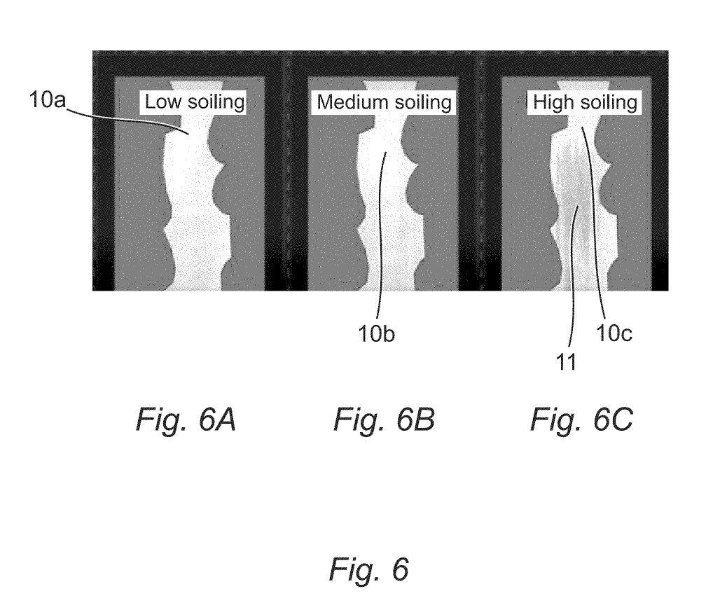

Defects which reduce the transparency of a substrate can vary widely. FIG. 6 shows three substrate samples (FIG. 6A, FIG. 6B and FIG. 6C), each having a region, 10a, 10b, 10c respectively, to be assessed for defects. The assessment region is illustrated by a light coloured area. Each of the three samples displays a defect of differing strength. The defect in FIG. 6A is small, in FIG. 6B the defect is of a medium strength, while in FIG. 6C the defect is very pronounced and is the strongest defect of the three samples. The defect in FIG. 6C is clearly seen as a grey mark 11 on the light sample area 10c.

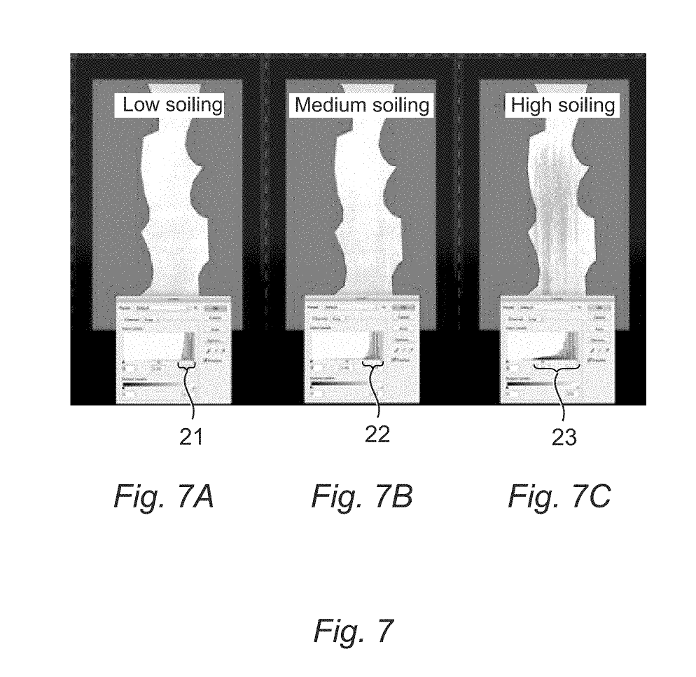

FIG. 7 shows the samples of FIG. 6 after processing using the method described above, where the statistical measure used is standard deviation. Images created by the imaging device can be greyscale or colour. In FIGS. 6 and 7 the images analysed were greyscale images. A greyscale digital image is an image in which the value of each pixel represents a level on a ‘grey’ scale, that is, it carries only intensity information. Images of this sort are composed exclusively of shades of grey, varying from black at the weakest intensity to white at the strongest. For example, an ‘8-bit’ greyscale image is an image in which each pixel can have one of 256 (2⁸) different grey levels between black and white. Using standard deviation as the statistical measure provides a measure of the spread of values of the pixels in the region. As the desired values of the pixels are white, indicating no defects, the spread from this value provides one measure of defect level.

The resulting standard deviation of each sample allows a defect score to be assigned to each of the samples. FIG. 7A shows only a small defect and the spread of pixel values 21 has a reasonably small width and hence a low standard deviation value. In FIG. 7B, the defect is more noticeable and subsequently the spread of pixel values 22 is wider than that of FIG. 7A and the standard deviation value is therefore also larger than that of FIG. 7A. The defect in FIG. 7C is very large and the spread of pixel values 23 is much wider than those of FIGS. 7A and 7B and hence the standard deviation of the light intensity data is much larger in FIG. 7C than that of FIGS. 7A and 7B. This occurs because as the defect becomes stronger, more pixel values have various shades of grey, resulting in a wider spread of grey values which in turn results in a higher standard deviation reading. Therefore, it is clear that as the defect in the region of the substrate becomes more substantial, a higher standard deviation reading of the digital image results. Thus, the method allows for an objective measure of defects, in window or other security devices, that reduce transparency of the substrate.

It is also possible to modify the above method to include colour images, where the statistical measure is calculated for each colour band. The colour bands can be any one of RGB (red, green, blue), HSV (hue, saturation, value), CMYK (cyan, magenta, yellow, key black) or any other recognised colour bands.

Experiments were conducted to compare the statistical measure defect assessment method described above with the manual defect assessment process. A number of statistical measures were evaluated, including, standard deviation, mean, mode, and median. The results of the experiments using the method with each of these statistical measurements are shown in Table 1 below, relative to ratings provided by skilled technicians conducting the manual process. In the experiments, a number of regions of various substrates were identified for analysis. An image of each region was created and labelled (column ‘Image’) and the area of each region to be analysed was also recorded (column ‘Area’). The defect score provided by a skilled technician using the manual defect assessment process for each region is provided in the column titled ‘Manual Assessment’ in Table 1. The statistical measures of the mean, standard deviation, mode and median of the light intensity of the analysed regions are provided in columns labelled ‘Mean’, ‘StdDev’, ‘Mode’, and ‘Median’, respectively.

TABLE 1

| | Manual | | | | | | | | | |
|---|---|---|---|---|---|---|---|---|---|---|
| Image | Assessment | Area | Mean | StdDev | Mode | Min | Max | IntDen | Median | RawIntDen |
| D038160-6A.tif | 1 | 1.11 | 62307.375 | 3612.687 | 65499 | 11516 | 65535 | 69136.069 | 61439 | 707953345054 |
| D038160-6E.tif | 1 | 1.101 | 61515.451 | 3691.252 | 61601 | 13062 | 65535 | 67723.922 | 61601 | 693492959189 |
| D061355-6G.tif | 1 | 1.104 | 60981.375 | 3863.45 | 61613 | 9204 | 65535 | 67310.301 | 61613 | 689257484476 |
| D016368-6B.tif | 2 | 1.106 | 62918.42 | 3455.803 | 65499 | 14046 | 65535 | 69568.762 | 65499 | 712384119672 |
| D066999-3C.tif | 2 | 1.102 | 62854.351 | 3597.341 | 65499 | 12554 | 65535 | 69268.662 | 65499 | 709311096205 |
| D016368-6C.tif | 2 | 1.103 | 62352.547 | 3661.884 | 65499 | 14068 | 65535 | 68756.745 | 61451 | 704069063819 |
| D035878-6C.tif | 3 | 1.1 | 61821.418 | 3947.863 | 65499 | 14058 | 65535 | 68001.356 | 61439 | 696333883015 |
| D035435-6C.tif | 3 | 1.1 | 61976.942 | 4241.211 | 65535 | 14080 | 65535 | 68188.884 | 61613 | 698254170133 |
| D016733-6E.tif | 3 | 1.094 | 59912.782 | 4315.201 | 61617 | 10640 | 65535 | 65574.037 | 61617 | 671478135712 |
| D058550-1F.tif | 4 | 1.104 | 62829.43 | 3609.181 | 65499 | 13968 | 65535 | 69376.913 | 65499 | 710419590849 |
| D034701-6A.tif | 4 | 1.108 | 60391.713 | 4182.312 | 61613 | 8774 | 65535 | 66933.799 | 61613 | 685402097494 |
| D035435-6H.tif | 4 | 1.102 | 60046.591 | 4518.69 | 61613 | 13900 | 65535 | 66198.164 | 61613 | 677869202880 |
| D063280-1H.tif | 4 | 1.1 | 60073.262 | 4980.492 | 61613 | 9828 | 65535 | 66096.909 | 61613 | 676832345222 |
| D021164-5G.tif | 5 | 1.11 | 61808.508 | 4012.199 | 65499 | 14042 | 65535 | 68638.13 | 61457 | 702854454516 |
| D016733-6F.tif | 5 | 1.11 | 61838.769 | 4281.811 | 65499 | 10934 | 65535 | 68651.022 | 61457 | 702986463836 |
| D061187-3C.tif | 5 | 1.102 | 61012.771 | 4360.96 | 61451 | 13728 | 65535 | 67252.721 | 61451 | 688667860858 |
| D035435-6E.tif | 5 | 1.106 | 61166.154 | 4410.337 | 65499 | 9510 | 65535 | 67674.424 | 61451 | 692986106321 |
| D020964-5F.tif | 6 | 1.097 | 61128.727 | 4329.872 | 65535 | 12840 | 65535 | 67055.145 | 61629 | 686644684761 |
| D060201-6C.tif | 6 | 1.1 | 61624.432 | 4403.801 | 65499 | 11750 | 65535 | 67812.789 | 61451 | 694402961649 |
| D061737-6A.tif | 6 | 1.105 | 61661.111 | 4508.577 | 65499 | 12088 | 65535 | 68108.147 | 61457 | 697427429486 |
| D061187-3D.tif | 7 | 1.101 | 61442.366 | 4378.451 | 65499 | 12088 | 65535 | 67625.34 | 61457 | 692483479899 |
| D036274-6C.tif | 7 | 1.107 | 58143.1 | 5412.642 | 57669 | 12724 | 65535 | 64347.707 | 57669 | 658920520765 |
| D036274-6G.tif | 7 | 1.107 | 59872.534 | 5708.47 | 65499 | 13918 | 65535 | 66292.408 | 61451 | 678834253337 |
| D037043-4E.tif | 8 | 1.093 | 61782.023 | 4809.716 | 65499 | 11250 | 65535 | 67556.953 | 61451 | 691783197618 |
| D038538-1D.tif | 8 | 1.104 | 62097.649 | 4950.481 | 65499 | 6708 | 65535 | 68585.416 | 65499 | 702314664500 |
| D034701-2D.tif | 8 | 1.101 | 60139.315 | 5878.229 | 61457 | 7158 | 65535 | 66224.122 | 61457 | 678135008434 |
| D034701-1F.tif | 8 | 1.103 | 58622.21 | 5996.342 | 61457 | 13968 | 65535 | 64679.648 | 61457 | 662319590816 |
| D055325-2G.tif | 8 | 1.095 | 60723.481 | 6183.585 | 65499 | 6864 | 65535 | 66513.596 | 61451 | 681099217964 |
| D038528-1H.tif | 9 | 1.102 | 59932.975 | 5816.498 | 65499 | 12314 | 65535 | 66035.392 | 61475 | 676202415313 |
| D036274-6F.tif | 9 | 1.105 | 58384.154 | 7007.809 | 65405 | 12442 | 65535 | 64520.294 | 61313 | 660687814771 |
| D036274-6E.tif | 9 | 1.105 | 57279.672 | 7265.853 | 61307 | 11832 | 65535 | 63287.118 | 57513 | 648060091791 |
| D039329-1D.tif | 9 | 1.104 | 58509.889 | 7570.375 | 61457 | 12368 | 65535 | 64589.803 | 61457 | 661399584696 |
| D038538-5D.tif | 10 | 1.103 | 60443.06 | 6631.352 | 65499 | 13676 | 65535 | 66674.113 | 61451 | 682742919978 |
| D067384-3B.tif | 10 | 1.099 | 60770.495 | 7466.006 | 65499 | 14026 | 65535 | 66812.328 | 61439 | 684158243528 |
| D067384-3C.tif | 10 | 1.097 | 57898.69 | 8738.472 | 61451 | 13054 | 65535 | 63538.327 | 61451 | 650632471105 |

As shown in Table 1, the defect scores that resulted from the manual process of identifying and rating defects conducted by a highly skilled quality assurance technician correlated most accurately to the standard deviation of the light intensity data. However, the other statistical measures, or a combination of those statistical measures could also be used in the defect measurement and assessment method.

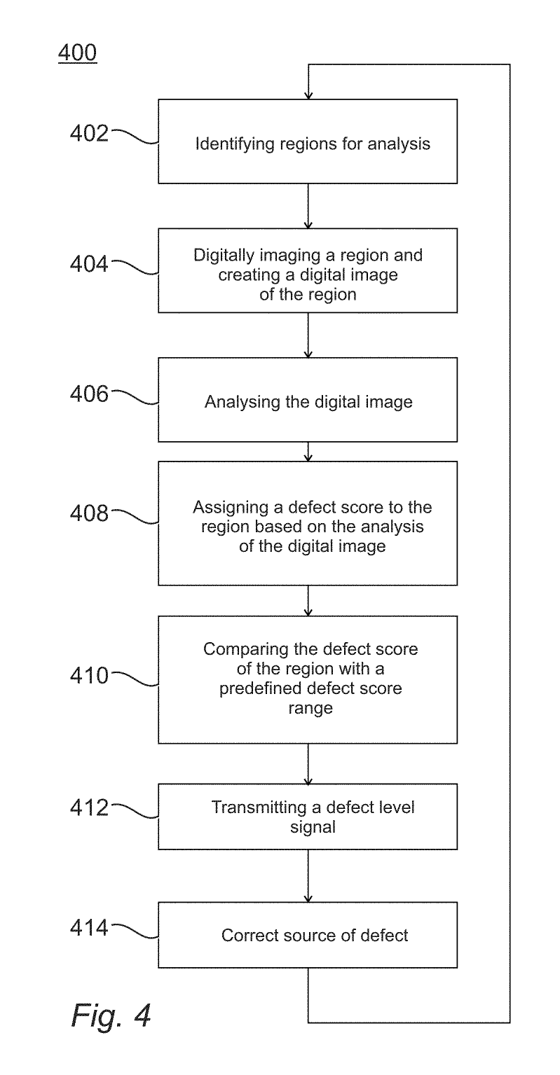

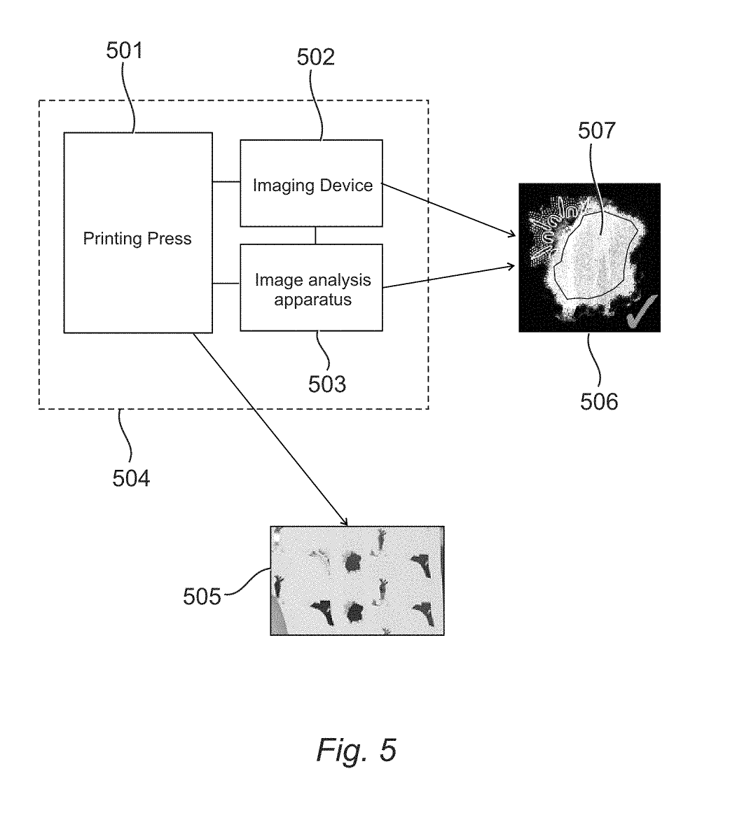

In another embodiment, the defect identification and measuring process can be carried out on a printing press as part of the printing process. The defect identification can be performed in-line as part of the printing process by digitally imaging relevant regions on the substrate and performing the statistical analysis of the resultant images. FIG. 5 shows a general printing press system 504 which uses the method of identifying and measuring defects 400 in a region of a substrate illustrated in FIG. 4. Rather than printing a batch of substrates and then identifying and measuring defects using the method described earlier, that is, separate from the printer and after the printing process is complete, the defect identification method can be integrated into the printing process. The method can be performed by a system 504 containing an imaging device 502 and image analysis apparatus 503 within the printing press 501 or otherwise integrated with the printing process, such as a system external to the printing press but connected to the printing press. In this way, defects can be identified more quickly and the reasons for the defects occurring can be rectified before too much product is spoilt. This process is more efficient than present methods currently used and has a number of advantages.

During the printing process, as each substrate 505 is printed, regions of the substrate are analysed for defects 507. This may be after each layer is printed or once the entire substrate is complete. Defects requiring minimising or correcting include, for example, those defects which reduce transparency of the substrate to unacceptable levels. As in the method described above, regions for analysis on the substrate are identified 402. The regions 507 of interest of the substrate are digitally imaged 404, forming digital images 506. The digital images contain light intensity data. These regions of interest can be pre-determined based on the substrate being printed and input into the imaging and analysis system 502, 503, thereby automating the imaging 404 and analysis 406 functions. The resulting digital images are then analysed 406 and a statistical measure of the light intensity data of the image is calculated. A number of statistical measures could be used, including, but not limited to: standard deviation; mean; mode; median; or any combination of those statistical measures. A defect score is then assigned 408 to the region 507 based on the statistical measure. This defect identification and analysis is performed in-line as part of the printing process. The printing press does not need to be stopped to conduct the analysis.

The defect score assigned to the region of the substrate is then compared 410 with a predefined defect score range. The predefined defect score range is set based on requirements for a particular application or product being printed. If the defect score of one of the regions is outside the predefined defect score range, that is, it is an unacceptable defect score for the region, this is identified by a defect level signal 412 and a process is put in place to correct the source of the defect 414 and hence rectify the region's unacceptable defect level. The printing press or the operator of the printing press may be able to identify what issue is causing the defect and adjust or correct the source of the defect. Issues that may cause defects may include incorrect parameters in the printing press, features of the printing press being misaligned or worn, or issues with the substrate.

The analysis of the printed substrate can be undertaken while the printing press continues to function. It may however be necessary, depending on the issue(s) causing the unacceptable defect level, to stop the printing process to rectify the issue causing the defect. A number of issues will be able to be rectified whilst the printing press continues to function or is only temporarily stopped. This reduces down time of the printing press and hence improves efficiency of the printing process.

Correcting the source of the defect may occur through various methods, including increasing blade pressure on the printing press, using a different blade angle, changing blades, using a new blade, reducing viscosity of the ink used, or using a different solvent.

This process is particularly advantageous because defects reducing the transparency of the region of the substrate can be identified and corrected as they occur resulting in less product containing unacceptable defect levels and hence reducing spoilage (waste product). Furthermore, the in-line identification of defects means that the printing press can be immediately adjusted to remove the defects. As manual defect inspection can only be done on off-line substrate, there is the potential for a whole print run to have defects which were not detected until inspection occurred (once the printing press was off-line). This would then require the entire print run to be repeated. The present method overcomes this disadvantage as it can function in line on the printing press. Furthermore, in the presently described method, adjustments can be made to correct defects without stopping the printing press, further reducing wastage.

Whilst the region of interest which is digitally imaged and analysed for defects may be small regions of various security devices on the substrate, it may also be the whole substrate sheet. In this way, the statistical measure of printed substrate sheets can be compared to the statistical measure of one or more template or ‘master’ substrate sheets which are considered to have a defect score within the acceptable defect score range.

In another embodiment, the methods of identifying and measuring defects described above can be used in a method of authenticating a security device in a security document. This method includes the steps of measuring a defect level of a region of a substrate containing the security device as described above. Then a defect score for the region containing the security device is determined. This defect score is then compared with a predefined defect score range which is indicative of an authentic security device. It can then be determined if the security document is authentic or otherwise based on the comparison.

Modifications and variations as would be deemed obvious to the person skilled in the art are included within the ambit of the present invention as claimed in the appended claims.

The claims defining the invention are as follows:

1. A method of measuring a defect level of a region of a substrate for a security document, wherein the defect level is associated with reduced transparency of the region of the substrate, the method including the steps of:
digitally imaging the region to create a digital image, the digital image containing light intensity data; and
analysing the digital image including:
calculating a statistical measure of the light intensity data in the region; and
assigning a defect score to the region based on the statistical measure of the light intensity data in the region.

2. The method according to claim 1 wherein the statistical measure is standard deviation.

3. The method according to claim 1, further including the step of:
comparing the defect score of each region with a predefined defect score range.

4. The method according to claim 3 further including the step of:
determining whether the defect score of each region is within the predefined defect score range based on said comparison.

5. The method according to claim 3 further including the step of:
transmitting a defect level signal to an output device based on said comparison.

6. The method according to claim 1, further including the steps of:
saving the digital image in a database; and
recording the defect score of the region in the database.

7. The method according to claim 1, wherein the digital image is a greyscale image.

8. The method according to claim 1, wherein the digital image is a colour image.

9. The method according to claim 8, wherein the light intensity data is in multiple colour bands.

10. The method according to claim 9, further including the step of:
calculating the statistical measure of the light intensity data in each colour band.

11. The method according to claim 9, wherein the multiple colour bands are any one of: RGB (red, green, blue); HSV (hue, saturation, value); or CMYK (cyan, magenta, yellow, key black).

12. The method according to claims 1, wherein the region is a security device.

13. A method of correcting a defect level in a printing press for printing a security document, including the steps of:
measuring a defect level of a region of a substrate for the security document using the method according to claim 1; and
comparing the defect score of the region with a predefined defect score range,
wherein, if the defect score of the region is outside the predefined defect score range, correcting the defect level in the printing press to be within the predefined defect score range.

14. A method of authenticating a security device in a security document including the steps of:
measuring a defect level of a region of a substrate for the security document according to the method of claim 1;
determining a defect score of the region;
comparing the defect score of the region with a predefined defect score range indicative of an authentic security device; and
determining if said security document comprising said region is authentic or otherwise based on said comparison.

15. A system for measuring a defect level of a region of a substrate for a security document, wherein the defect level is associated with reduced transparency of the region of the substrate and providing information about a quality of the substrate of the security document, including:
an imaging device for creating a digital image of an area of the substrate containing the region, the digital image containing light intensity data; and
an image analysis apparatus for:
calculating a statistical measure of the light intensity data in the region; and
assigning a defect score to the region based on the statistical measure of the light intensity data in the region.

16. A system for measuring a defect level of a region of a substrate for a security document according to claim 15 wherein the image analysis apparatus further carries out the steps of:
comparing the defect score of the region with a predefined defect score range;
determining whether the defect score of each region is within the predefined defect score range based on said comparison; and
transmitting a defect level signal to an output device, based on said comparison.
